(19) United States
(12) Patent Application Publication
(10) Pub. No.: US 2023/0080393 A1
(43) Pub. Date: Mar. 16, 2023

(54) METHODS AND SYSTEMS FOR QUANTUM SIMULATION OF MOLECULAR AND SPIN SYSTEMS

(71) Applicant: GOOD CHEMISTRY INC., Vancouver (CA)

(72) Inventor: Shunji MATSUURA, Vancouver (CA)

(21) Appl. No.: 18/046,320

(22) Filed: Oct. 13, 2022

Related U.S. Application Data
(63) Continuation of application No. PCT/CA2021/050513, filed on Apr. 16, 2021.
(60) Provisional application No. 63/011,766, filed on Apr. 17, 2020.

(51) Int. Cl. G06N 10/60; G06N 10/20

(52) U.S. Cl. CPC G06N 10/60; G06N 10/20

(57) ABSTRACT

A method of solving a problem using a digital computer operatively coupled to a non-classical computer may include providing a qubit Hamiltonian in said memory, wherein said qubit Hamiltonian comprises two-qubit coupling interactions on at least two axes; using said one or more computer processors to generate a unitary transformation, wherein said unitary transformation comprises an expression of a first two-qubit coupling interaction on a first axis using a second two-qubit coupling interaction on a second axis, which first axis is orthogonal to said second axis; embedding said qubit Hamiltonian on said non-classical computer; implementing said unitary transformation on said non-classical computer to apply a two-qubit coupling interaction along said first axis; and providing an expected value of said qubit Hamiltonian at an interface of said computer processor, wherein said expected value comprises said solution to said problem.

### CROSS-REFERENCE

This application is a continuation of International Application No. PCT/CA2021/050513, filed Apr. 16, 2021, which claims the benefit of U.S. Provisional Application Ser. No. 63/011,766, filed Apr. 17, 2020, which are incorporated herein by reference in its entirety.

### BACKGROUND

Quantum computers may be capable of solving various problems which may be intractable or inefficient on a classical computer. For example, computing solutions to problems which include many-body interactions may be more efficiently solved on a quantum computer. There are various challenges to practical quantum computation among these are noise, errors, limited qubits, short coherence lifetimes, etc. The accuracy of results may decrease rapidly as the number of gate operations and/or the number of measurements increases.

### SUMMARY

Recognized herein is the need for improved methods, systems, and media for performing non-classical computations.

Systems, methods, and media disclosed herein may enable problems to be solved more efficiently and/or more accurately with fewer two-qubit coupling interactions. For example, non-classical computing devices may have limited available control over two-qubit interactions or may not have two-qubit gates available in each of the three coordinate dimensions. Methods, systems, and media disclosed herein may aid in implementation of two-qubit coupling interactions on non-classical computers with limited ability to implement two-qubit gates. Methods, systems, and media disclosed herein may allow classical computers with limited types two-qubit gates to simulate other two-qubit gates more efficiently and/or with fewer total gate operations in the simulation.

In another aspect, a method of solving a problem using a digital computer operatively coupled to a non-classical computer is provided. In some embodiments, the digital computer may comprise computer memory and one or more computer processors operatively coupled to the memory. In some embodiments, a solution to the problem comprises a quantum state. The method may comprise: providing a qubit Hamiltonian in the memory, wherein the qubit Hamiltonian comprises at least one non-native qubit coupling or operation; using the one or more computer processors to generate a unitary transformation, wherein a native qubit coupling or operation of said qubit Hamiltonian and a one qubit operation are used in generating said unitary transformation comprising said non-native qubit coupling or operation; applying the unitary transformation on the non-classical computer; and providing an expected value of the qubit Hamiltonian at an interface of the computer processor, wherein the expected value comprises the solution to the problem.

In some embodiments, the qubit Hamiltonian is a two-local qubit Hamiltonian. In some embodiments, the two-local qubit Hamiltonian comprises XX, ZZ, X and Z interactions. In some embodiments, the expected value is an expected value of a ground state energy or an excited state energy. In some embodiments, the method further comprises: providing a Hamiltonian in the memory; and using the one or more computer processors to transform the Hamiltonian into the qubit Hamiltonian. In some embodiments, the Hamiltonian is in a form selected from the group consisting of a second quantized fermionic Hamiltonian, a second quantized bosonic Hamiltonian and a spin Hamiltonian. In some embodiments, the using the one or more computer processors to transform the Hamiltonian into a qubit Hamiltonian comprises Bravyi-Kitaev transformation. In some embodiments, the using the one or more computer processors to transform the Hamiltonian into a qubit Hamiltonian is performed using the perturbative gadgets.

In some embodiments, a method of simulating a quantum chemistry problem comprising the method for solving a problem of any embodiment is provided. In some embodiments, the non-classical computer comprises a quantum simulator. In some embodiments, the non-classical computer comprises a quantum annealer. In some embodiments, the non-classical computer comprises a gate model quantum computer.

In another aspect, a system for solving a problem, wherein a solution to the problem comprises a quantum state is provided. The system may comprise: memory configured to store a qubit Hamiltonian, wherein the qubit Hamiltonian comprises at least one non-native qubit operation; a communications interface configured to communicate with a non-classical computer; and one or more computer processors operatively coupled to the memory, wherein the one or more computer processors are individually or collectively programmed to (1) embed the qubit Hamiltonian on the non-classical computer, wherein the qubit Hamiltonian comprises at least one non-native qubit operation; (2) generate a unitary transformation comprising the at least one non-native qubit operation in terms of one or more native qubit operations; (3) implement the unitary transformation on the non-classical computer to apply the at least one non-native qubit operation; (4) use a variational ansatz to generate an expected value of the qubit Hamiltonian; and (5) provide the expected value of the qubit Hamiltonian at an interface of the one or more computer processors, wherein the expected value comprises the solution to the problem.

In another aspect, the present disclosure provides a non-transitory computer readable medium comprising machine-executable code, that upon execution by a digital computer operatively coupled to a non-classical computer, implements a method for solving a problem, wherein the digital computer comprises one or more computer processors and a memory and

wherein a solution to the problem comprises a quantum state. The method may comprise: providing a qubit Hamiltonian in the memory, wherein the qubit Hamiltonian comprises at least one non-native qubit coupling or operation; using the one or more computer processors to generate a unitary transformation, wherein a native qubit coupling or operation of said qubit Hamiltonian and a one qubit operation are used in generating said unitary transformation comprising said non-native qubit coupling or operation; applying the unitary transformation on the non-classical computer; and providing an expected value of the qubit Hamiltonian at an interface of the computer processor, wherein the expected value comprises the solution to the problem.

In an aspect, a method for solving a quantum problem using a digital computer operatively coupled to a quantum computer is provided. In some embodiments, the digital computer comprises computer memory and one or more computer processors operatively coupled to the memory. In some embodiments, a solution to the quantum problem comprises a quantum state. The method may comprise: (a) providing a Hamiltonian representative of a cost function in the memory; (b) providing a quantum Hamiltonian in the memory, wherein the quantum Hamiltonian is representative of a Hamiltonian to be implemented on the quantum computer and wherein an evolution with respect to the quantum Hamiltonian relates to a reduction of a value of the cost function; (c) using the one or more computer processors to transform the quantum Hamiltonian into a qubit Hamiltonian, wherein the qubit Hamiltonian comprises a non-native qubit coupling; (d) generating an initial value for each variational parameter of a set of variational parameters in the memory; (e) providing a single qubit Hamiltonian, wherein the single qubit Hamiltonian comprises a first variational parameter of the set of variational parameters; (f) providing an initial state in the memory; (g) setting a current state on the quantum computer to be the initial state; (h) using the one or more computer processors to generate a unitary transformation comprising a non-native qubit coupling of the qubit Hamiltonian, wherein a native qubit coupling of the qubit Hamiltonian and a one qubit operation are used in generating the unitary transformation comprising the non-native qubit couplings; (i) until a stopping criterion is met: (1) applying a unitary transformation comprising the native qubit coupling of the qubit Hamiltonian to the current state using the quantum computer, wherein the unitary transformation comprising the native qubit coupling of the qubit Hamiltonian comprises a subset of variational parameters of the set of variational parameters; (2) applying the unitary transformation comprising the non-native qubit couplings of the qubit Hamiltonian to a resultant state using the quantum computer, wherein the unitary transformation comprising the non-native qubit couplings of the qubit Hamiltonian comprises said subset of variational parameters of the set of variational parameters; and (3) applying a unitary transformation comprising the single qubit Hamiltonian to the resultant state using the quantum computer wherein said unitary transformation comprising said single qubit Hamiltonian comprises said subset of variational parameters of said set of variational parameters; (4) repeating (1)-(3) at least one time; (5) using the one or more computer processors to estimate an expected value of the Hamiltonian representative of the cost function; (6) updating the set of variational parameters in the memory; and (j) providing the expected value of the Hamiltonian representative of the cost function at an interface of the computer processor, wherein the expected value comprises the solution to the quantum problem.

In some embodiments, the Hamiltonian representative of a cost function is the quantum Hamiltonian or a second quantum Hamiltonian different from said quantum Hamiltonian. In some embodiments, the Hamiltonian representative of a cost function is a molecular Hamiltonian. In some embodiments, the quantum Hamiltonian is an Ising or a QUBO Hamiltonian. In some embodiments, the method further comprises using the one or more computer processors to transform the quantum Hamiltonian representative of the cost function into a qubit Hamiltonian. In some embodiments, the qubit Hamiltonian comprises native XX and ZZ couplings and native X and Z one qubit operations. In some embodiments, the quantum state is a ground state or an excited state. In some embodiments, the Hamiltonian representative of a cost function or the quantum Hamiltonian is in a form selected from the group consisting of a second quantized fermionic Hamiltonian, a second quantized bosonic Hamiltonian and a spin Hamiltonian. In some embodiments, the using the one or more computer processors to transform the Hamiltonian into a qubit Hamiltonian comprises a Bravyi-Kitaev transformation. In some embodiments, the using the one or more computer processors to transform the Hamiltonian into a qubit Hamiltonian is performed using the perturbative gadgets. In some embodiments, a method of simulating a quantum chemistry problem comprising the method for solving a quantum problem of any embodiment is provided.

In some embodiments, the quantum computer comprises a quantum simulator. In some embodiments, the quantum computer comprises a quantum annealer. In some embodiments, the quantum computer comprises a gate model quantum computer. In some embodiments, the stopping criterion comprises a completion of a selected number of iterations or wherein the stopping criterion comprises a change in the expected value of qubit Hamiltonian or a Hamiltonian representative of a cost function being below a threshold condition.

In another aspect, a system for solving a quantum problem is provided. In some embodiments, a solution to the problem comprises a quantum state. The system may comprise: memory configured to store a Hamiltonian representative of a cost function, a quantum Hamiltonian, a set of variational parameters, a single qubit Hamiltonian, and an initial state of the Hamiltonian; a communications interface configured to communicate with a quantum computer; one or more computer processors operatively coupled to the memory, wherein the one or more computer processors are individually or collectively programmed to: (1) generate at least one variational parameter; (2) transform the Hamiltonian into a qubit Hamiltonian, wherein the qubit Hamiltonian comprises XX, ZZ, X, and Z interactions; (3) set a current state to be an initial state on the quantum computer; (4) generate a unitary transformation comprising the XX, and X interactions of the qubit Hamiltonian, wherein the unitary transformation comprising the XX and X interactions comprises an expression in terms of ZZ and Z interactions and the one qubit operations; (5) direct the quantum computer to implement one or more unitary operations until a stopping criterion is met; (6) estimate an expected value of the qubit Hamiltonian a current state of the quantum computer; (7) update the at least one variational parameter in the memory; and (8) provide the expected value of the qubit Hamiltonian at an interface of the computer processor, wherein the expected value comprises the solution to the quantum problem; and the quantum computer configured to implement one or more unitary operations comprising: (1) a unitary transformation comprising the single qubit Hamiltonian and the at least one variational parameter; (2) a unitary transformation comprising the ZZ and Z interactions of the qubit Hamiltonian corresponding to the at least one variational parameter; and (3) the unitary transformation comprising the XX and X interactions Hamiltonian corresponding to the at least one variational parameter.

In another aspect, a system for solving a quantum problem, wherein a solution to said problem comprises a quantum state is provided. The system may comprise: memory configured to store a Hamiltonian representative of a cost function, a quantum Hamiltonian, a set of variational parameters, a single qubit Hamiltonian, and an initial state of said Hamiltonian; a communications interface configured to communicate with a quantum computer; one or more computer processors operatively coupled to said memory, wherein said one or more computer processors are individually or collectively programmed to: (1) an initial value for each variational parameter of a set of variational parameters; (2) transform said Hamiltonian representative of said cost function into a qubit Hamiltonian, wherein said qubit Hamiltonian comprises a non-native qubit coupling interaction; (3) set a current state to be an initial state on said quantum computer; (4) generate a unitary transformation comprising non-native qubit couplings and operations of said qubit Hamiltonian, wherein native qubit couplings and operations of said qubit Hamiltonian and one qubit operations are used in generating said unitary transformation comprising said non-native qubit couplings and operations; (5) direct said quantum computer to implement one or more unitary operations until a stopping criterion is met; (6) estimate an expected value of said Hamiltonian representative of the cost function; (7) said set of variational parameters in said memory; and (8) provide said expected value of said Hamiltonian representative of the cost function at an interface of said computer processor, wherein said expected value comprises said solution to said quantum problem; and said quantum computer configured to implement one or more unitary operations comprising: (1) applying a unitary transformation comprising said native qubit couplings and operations of said qubit Hamiltonian to the current state using said quantum computer, wherein said unitary transformation comprising said native qubit couplings and operations of said qubit Hamiltonian comprises a subset of variational parameters of said set of variational parameters; (2) unitary transformation comprising said native qubit couplings and operations of said qubit Hamiltonian to the current state using said quantum computer, wherein said unitary transformation comprising said native qubit couplings and operations of said qubit Hamiltonian comprises said subset of variational parameters of said set of variational parameters; and (3) a unitary transformation comprising said single qubit Hamiltonian to the resultant state using said quantum computer, wherein said unitary transformation comprising said single qubit Hamiltonian comprises said subset of variational parameters of said set of variational parameters.

In another aspect, a non-transitory computer readable medium is provided. The medium may comprise machine-executable code, that upon execution by a digital computer operatively coupled to a quantum computer, implements a method for solving a quantum problem, wherein the digital computer comprises one or more computer processors and a memory and wherein a solution to the problem comprises a quantum state. The method may comprise: (a) providing a Hamiltonian representative of a cost function in the memory; (b) providing a quantum Hamiltonian in the memory, wherein the quantum Hamiltonian is representative of a Hamiltonian to be implemented on the quantum computer and wherein an evolution with respect to the quantum Hamiltonian relates to a reduction of a value of the cost function; (c) using the one or more computer processors to transform the quantum Hamiltonian into a qubit Hamiltonian, wherein the qubit Hamiltonian comprises a non-native qubit coupling; (d) generating an initial value for each variational parameter of a set of variational parameters in the memory; (e) providing a single qubit Hamiltonian, wherein the single qubit Hamiltonian comprises a first variational parameter of the set of variational parameters; (f) providing an initial state in the memory; (g) setting a current state on the quantum computer to be the initial state; (h) using the one or more computer processors to generate a unitary transformation comprising a non-native qubit coupling of the qubit Hamiltonian, wherein a native qubit coupling of the qubit Hamiltonian and a one qubit operation are used in generating the unitary transformation comprising the non-native qubit couplings; (i) until a stopping criterion is met: (1) applying a unitary transformation comprising the native qubit coupling of the qubit Hamiltonian to the current state using the quantum computer, wherein the unitary transformation comprising the native qubit coupling of the qubit Hamiltonian comprises a subset of variational parameters of the set of variational parameters; (2) applying the unitary transformation comprising the non-native qubit couplings of the qubit Hamiltonian to a resultant state using the quantum computer, wherein the unitary transformation comprising the non-native qubit couplings of the qubit Hamiltonian comprises said subset of variational parameters of the set of variational parameters; and (3) applying a unitary transformation comprising the single qubit Hamiltonian to the resultant state using the quantum computer wherein said unitary transformation comprising said single qubit Hamiltonian comprises said subset of variational parameters of said set of variational parameters; (4) repeating (1)-(3) at least one time; (5) using the one or more computer processors to estimate an expected value of the Hamiltonian representative of the cost function; (6) updating the set of variational parameters in the memory; and (j) providing the expected value of the Hamiltonian representative of the cost function at an interface of the computer processor, wherein the expected value comprises the solution to the quantum problem.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 illustrates a flow chart of an example of a method for solving a quantum problem, in accordance with some embodiments.

FIG. 2 illustrates a flow chart of an embodiment of the example of a method for solving a quantum problem of FIG. 1.

FIG. 3 shows the operation of an example quantum simulator, in accordance with some embodiments.

FIG. 4 shows an example implementation of a unitary transformation with reduced two-qubit interactions on a quantum annealer, in accordance with some embodiments.

FIG. 5 show the operation of an example circuit for simulating H₂.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The present disclosure provides systems, methods, and media for solving a problem (e.g., a quantum problem) using a digital computer operatively coupled to a quantum computer. A problem may comprise various quantum chemistry problems such as finding or predicting a the quantum mechanical energy of a state, finding or predicating a most stable conformer, finding or predicting a chemical structure, finding or predicting vibrational modes, finding or predicting one or more chemical properties such as, for example, optical properties (ionization potential, absorption spectra, Raman spectra, Auger spectra, etc.), magnetic properties (NMR spectra, magnetic susceptibility, etc.), potential energy surfaces, bond dissociation energies, etc.

Systems, methods, and media disclosed herein may enable problems to be solved more efficiently and/or more accurately with fewer two-qubit coupling interactions. For example, non-classical computing devices may have limited available control over two-qubit interactions or may not have two-qubit gates available in each of the three coordinate dimensions. In some cases, a method of solving a problem using a digital computer operatively coupled to a non-classical computer may comprise providing a qubit Hamiltonian in a memory of a digital computer. The qubit Hamiltonian may comprise two-qubit coupling interactions on at least two axes. In some cases, a method of solving a problem using a digital computer operatively coupled to a non-classical computer may comprise using one or more computer processors to generate a unitary transformation. The unitary transformation may comprise an expression of a first two-qubit coupling interaction on a first axis using a second two-qubit coupling interaction on a second axis, which axis is orthogonal to the second axis. In some cases, a method of solving a problem using a digital computer operatively coupled to a non-classical computer may comprise embedding the qubit Hamiltonian on a non-classical computer. In some cases, a method of solving a problem using a digital computer operatively coupled to a non-classical computer may comprise implementing the unitary transformation on the non-classical computer to apply a two-qubit coupling interaction along the first axis. In some cases, a method of solving a problem using a digital computer operatively coupled to a non-classical computer may comprise providing an expected value of the qubit Hamiltonian at an interface, wherein the expected value comprises the solution to the problem.

### Non-Classical Computer

The present disclosure provides systems and methods that may include quantum computing or use of quantum computing. Quantum computers may be able to solve certain classes of computational tasks more efficiently than classical computers. However, quantum computation resources may be rare and expensive, and may involve a certain level of expertise to be used efficiently or effectively (e.g., cost-efficiently or cost-effectively). A number of parameters may be tuned in order for a quantum computer to deliver its potential computational power.

Quantum computers (or other types of non-classical computers) may be able to work alongside classical computers as co-processors. A hybrid architecture (e.g., computing system) comprising a classical computer and a quantum computer can be very efficient for addressing complex computational tasks, such as quantum chemistry simulations. Systems and methods disclosed herein may be able to efficiently and accurately implement a quantum problem on a non-classical computer with a reduced number of two-qubit coupling interactions.

Although the present disclosure has made reference to quantum computers, methods and systems of the present disclosure may be employed for use with other types of computers, which may be non-classical computers. Such non-classical computers may comprise quantum computers, hybrid quantum computers, quantum-type computers, or other computers that are not classical computers. Examples of non-classical computers may include, but are not limited to, Hitachi Ising solvers, coherent Ising machines based on optical parameters, and other solvers which utilize different physical phenomena to obtain more efficiency in solving particular classes of problems.

In some cases, a quantum computer may comprise one or more adiabatic quantum computers, quantum gate arrays, one-way quantum computers, topological quantum computers, quantum Turing machines, superconductor-based quantum computers, trapped ion quantum computers, trapped atom quantum computers, optical lattices, quantum dot computers, spin-based quantum computers, spatial-based quantum computers, Loss-DiVincenzo quantum computers, nuclear magnetic resonance (NMR) based quantum computers, solution-state NMR quantum computers, solid-state NMR quantum computers, solid-state NMR Kane quantum computers, electrons-on-helium quantum computers, cavity-quantum-electrodynamics based quantum computers, molecular magnet quantum computers, fullerene-based quantum computers, linear optical quantum computers, diamond-based quantum computers, nitrogen vacancy (NV) diamond-based quantum computers, Bose-Einstein condensate-based quantum computers, transistor-based quantum computers, and rare-earth-metal-ion-doped inorganic crystal based quantum computers. A quantum computer may comprise one or more of: quantum annealers, Ising solvers, optical parametric oscillators (OPO), and gate models of quantum computing.

In some cases, a non-classical computer of the present disclosure may comprise a noisy intermediate-scale quantum device. The term Noisy Intermediate-Scale Quantum (NISQ) was introduced by John Preskill in “Quantum Computing in the NISQ era and beyond.” arXiv:1801.00862. Here, “Noisy” may imply that incomplete control over the qubits is present and the “Intermediate-Scale” may refer to the number of qubits which could range from 50 to a few hundreds. Several physical systems made from superconducting qubits, artificial atoms, ion traps are proposed so far as feasible candidates to build NISQ quantum device and ultimately universal quantum computers.

In some cases, a classical simulator of the quantum circuit can be used which can run on a classical computer like a MacBook Pro® laptop, a Windows® laptop, or a Linux® laptop. In some cases, the classical simulator can run on a cloud computing platform having access to multiple computing nodes in a parallel or distributed manner. In some cases, all or a portion of a quantum mechanical energy and/or electronic structure calculation may be performed using the classical simulator.

The methods described herein may be performed on an analogue quantum simulator. An analogue quantum simulator may be a quantum mechanical system consisting of a plurality of manufactured qubits. An analogue quantum simulator may be designed to simulate quantum systems by using physically different but mathematically equivalent or approximately equivalent systems. In an analogue quantum, each qubit may be realized in an ion of strings of trapped atomic ions in linear radiofrequency traps. To each qubit may be coupled a source of bias called a local field bias. The local field biases on the qubits may be programmable and controllable. In some cases, a qubit control system comprising a digital processing unit is connected to the system of qubits and is capable of programming and tuning the local field biases on the qubits.

An analogue quantum simulator may furthermore comprise a plurality of couplings between a plurality of one or more subgroupings (e.g., pairs, trios, quartets, etc.) of the plurality of qubits. The strength of the couplings may be programable and controllable. In some cases, the simulator may be capable of natively implementing certain types of couplings. For example, a coupling or interaction may be a coupling or interaction between a first qubit and a second qubit. In some cases, a native coupling or interaction may be an interaction between two qubits along the same axis. In some cases, a native qubit coupling operation may be any one or any two interactions between two qubits along the same axis. For example, a native coupling or interaction may be an XX interaction or an XX and a ZZ interaction. In some cases, a native coupling or interaction may be an interaction between two qubits along different axes. For example, a native qubit interaction may comprise less than six of interactions between two qubits along different axes, for example, less than six of: XY, XZ, YX, YZ, ZX, and ZY. For example, a native qubit interaction may comprise any combination of two-qubit interactions along the same axis and two-qubit interactions along different axes.

A simulator may be capable of one or more one qubit operations, for example, one qubit rotations. In some cases, a simulator may be capable of natively implement certain types of one qubit operations but not others. A one qubit operation may comprise a rotation along an axis (e.g., a Pauli rotation along an axis of the Bloch sphere). In some cases, a native one qubit operation may be any one or any two Pauli rotations. For example, a simulator may be capable X-rotations only or X and Z rotations only.

A non-native coupling or operation may be a coupling or interaction which a simulator may not be capable of implementing directly. For example, a non-native coupling or interaction may be any one interaction or coupling of two-qubits along the same axis. In some cases, a native coupling or interaction may be an interaction between two qubits along different axes. For example, a native qubit interaction may comprise at least one interaction or coupling between two qubits along different axes, for example, at least one of: XY, XZ, YX, YZ, ZX, and ZY. For example, a native qubit interaction may comprise any combination of two-qubit interactions along the same axis and two-qubit interactions along different axes. In some cases, a non-native coupling or interaction may be an XZ interaction.

In some cases, the couplings between qubits are generated by pulses of laser and microwave radiation. In some cases, an analogue quantum simulator performs a transformation of a molecular model from an initial setup to a final one. In some cases, the initial and final setups of the quantum problems provide quantum systems described by their corresponding initial and final Hamiltonians.

### Classical Computer

In some cases, a classical computer may be configured to perform one or more classical algorithms. A classical algorithm (or classical computational task) may comprise an algorithm (or computational task) that is able to be executed by one or more classical computers without the use of a quantum computer, a quantum-ready computing service, or a quantum-enabled computing service. A classical algorithm may comprise a non-quantum algorithm. A classical computer may comprise a computer which does not comprise a quantum computer, a quantum-ready computing service, or a quantum-enabled computer. A classical computer may process or store data represented by digital bits (e.g., zeroes (“0”) and ones (“1”)) rather than quantum bits (qubits). Examples of classical computers include, but are not limited to, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles.

A hybrid computing unit may comprise a classical computer and quantum computer. A quantum computer may be configured to perform one or more quantum algorithms for solving a quantum problem (e.g., at least a portion of a quantum chemistry simulation). The one or more quantum algorithms may be executed using a quantum computer, a quantum-ready computing service, or a quantum-enabled computing service. For instance, the one or more quantum algorithms may be executed using the systems or methods described in U.S. Patent Publication No. 2018/0107526, entitled “METHODS AND SYSTEMS FOR QUANTUM READY AND QUANTUM ENABLED COMPUTATIONS”, which is entirely incorporated herein by reference. The classical computer may comprise at least one classical processor and computer memory and may be configured to perform one or more classical algorithms for solving a computational problem (e.g., at least a portion of a quantum chemistry simulation). The digital computer may comprise at least one computer processor and computer memory, wherein the digital computer may include a computer program with instructions executable by the at least one computer processor to render an application. The application may facilitate use of the quantum computer and/or the classical computer by a user.

Some implementations may use quantum computers along with classical computers operating on bits, such as personal desktops, laptops, supercomputers, distributed computing, clusters, cloud-based computing resources, smartphones, or tablets.

The system may comprise an interface for a user. In some cases, the interface may comprise an application programming interface (API). The interface may provide a programmatic model that abstracts away (e.g., by hiding from the user) the internal details (e.g., architecture and operations) of the quantum computer. In some cases, the interface may minimize a need to update the application programs in response to changing quantum hardware. In some cases, the interface may remain unchanged when the quantum computer has a change in internal structure.

In some cases, the systems, media, networks, and methods described herein comprise a classical computer, or use of the same. In some cases, the classical computer includes one or more hardware central processing units (CPUs) that carry out the classical computer's functions. In some cases, the classical computer further comprises an operating system (OS) configured to perform executable instructions. In some cases, the classical computer is connected to a computer network. In some cases, the classical computer is connected to the Internet such that it accesses the World Wide Web. In some cases, the classical computer is connected to a cloud computing infrastructure. In some cases, the classical computer is connected to an intranet. In some cases, the classical computer is connected to a data storage device.

In accordance with the description herein, suitable classical computers may include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Smartphones may be suitable for use with methods and systems described herein. Select televisions, video players, and digital music players, in some cases with computer network connectivity, may be suitable for use in the systems and methods described herein. Suitable tablet computers may include those with booklet, slate, and convertible configurations.

In some cases, the classical computer includes an operating system configured to perform executable instructions. The operating system may be, for example, software, including programs and data, which manages the device's hardware and provides services for execution of applications. Suitable server operating systems include, by way of non-limiting examples, FreeBSD, OpenBSD, NetBSD®, Linux, Apple® Mac OS X Server®, Oracle® ^{Solaris}®, Windows Server®, and Novell® NetWare®. Suitable personal computer operating systems may include, by way of non-limiting examples, Microsoft® Windows®, Apple® Mac OS X®, UNIX®, and UNIX-like operating systems such as GNU/Linux®. In some cases, the operating system is provided by cloud computing. Suitable mobile smart phone operating systems may include, by way of non-limiting examples, Nokia® Symbian® OS, Apple iOS®, Research In Motion BlackBerry OS®, Google Android®, Microsoft® Windows Phone® OS, Microsoft® Windows Mobile® OS, Linux®, and Palm WebOS®. Suitable media streaming device operating systems may include, by way of non-limiting examples, Apple TV®, Roku®, Boxee®, Google TV®, Google Chromecast®, Amazon Fire®, and Samsung® HomeSync®. Suitable video game console operating systems may include, by way of non-limiting examples, Sony® PS3®, Sony® PS4®, Microsoft® Xbox 360®, Microsoft Xbox One, Nintendo® Wii®, Nintendo® Wii U®, and Ouya®.

In some cases, the classical computer includes a storage and/or memory device. In some cases, the storage and/or memory device is one or more physical apparatuses used to store data or programs on a temporary or permanent basis. In some cases, the device is volatile memory and requires power to maintain stored information. In some cases, the device is non-volatile memory and retains stored information when the classical computer is not powered. In some cases, the non-volatile memory comprises flash memory. In some cases, the non-volatile memory comprises dynamic random-access memory (DRAM). In some cases, the non-volatile memory comprises ferroelectric random-access memory (FRAM). In some cases, the non-volatile memory comprises phase-change random access memory (PRAM). In other cases, the device is a storage device including, by way of non-limiting examples, CD-ROMs, DVDs, flash memory devices, magnetic disk drives, magnetic tapes drives, optical disk drives, and cloud computing-based storage. In some cases, the storage and/or memory device is a combination of devices such as those disclosed herein.

In some cases, the classical computer includes a display to send visual information to a user. In some cases, the display is a cathode ray tube (CRT). In some cases, the display is a liquid crystal display (LCD). In some cases, the display is a thin film transistor liquid crystal display (TFT-LCD). In some cases, the display is an organic light emitting diode (OLED) display. In some cases, on OLED display is a passive-matrix OLED (PMOLED) or active-matrix OLED (AMOLED) display. In some cases, the display is a plasma display. In other cases, the display is a video projector. In some cases, the display is a combination of devices such as those disclosed herein.

In some cases, the classical computer includes an input device to receive information from a user. In some cases, the input device is a keyboard. In some cases, the input device is a pointing device including, by way of non-limiting examples, a mouse, trackball, track pad, joystick, game controller, or stylus. In some cases, the input device is a touch screen or a multi-touch screen. In some cases, the input device is a microphone to capture voice or other sound input. In some cases, the input device is a video camera or other sensor to capture motion or visual input. In some cases, the input device is a Kinect, Leap Motion, or the like. In some cases, the input device is a combination of devices such as those disclosed herein.

### Non-Transitory Computer Readable Storage Medium

In some cases, the systems and methods described herein include one or more non-transitory computer readable storage media encoded with a program including instructions executable by the operating system of an optionally networked digital processing device. In some cases, a computer readable storage medium is a tangible component of a classical computer. In some cases, a computer readable storage medium is optionally removable from a classical computer. In some cases, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Providing a Qubit Hamiltonian

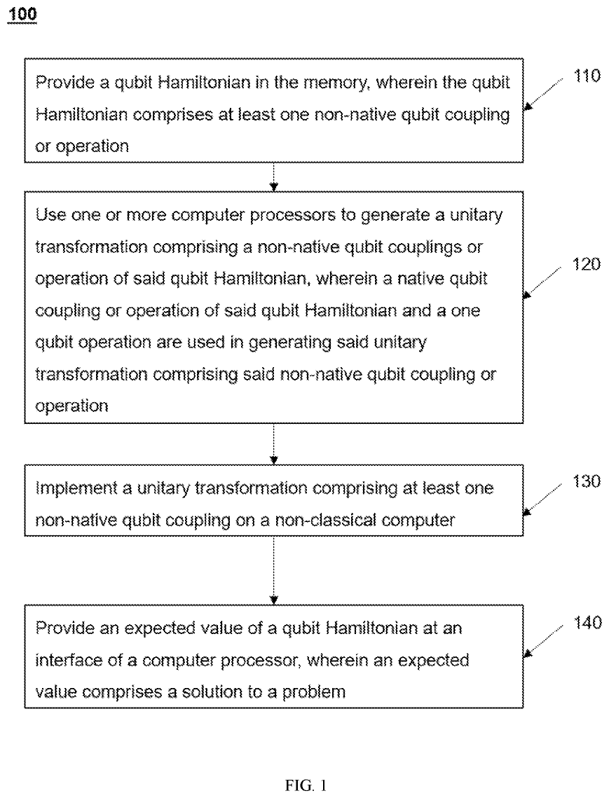

FIG. 1 illustrates a flow chart of an example method 100 for solving a quantum problem. The method 100 of solving a problem using a digital computer operatively coupled to a non-classical computer may comprise providing a qubit Hamiltonian in a memory of a digital computer according to operation 110. The qubit Hamiltonian may comprise native and non-native qubit couplings and/or operations. The qubit Hamiltonian may comprise at least one non-native qubit coupling. While the Hamiltonian of a molecular system is described in at least some of the examples, various other Hamiltonians may be used with methods, systems, and media of the present disclosure. Hamiltonians with many body interactions in multiple axes may benefit from aspects of the present disclosure.

In some cases, a Hamiltonian may not be in the form of a qubit Hamiltonian. A Hamiltonian may be transformed to a qubit Hamiltonian. In some cases, the Hamiltonian is in a form selected from the group consisting of a second quantized fermionic Hamiltonian, a second quantized bosonic Hamiltonian and a spin Hamiltonian. For example, a Hamiltonian may be in the form of a second quantized fermionic Hamiltonian. For example, a Hamiltonian may be in the form of a second quantized bosonic Hamiltonian. For example, a Hamiltonian may be in the form of a second quantized spin Hamiltonian. A qubit Hamiltonian may generally be a transformation of the Hamiltonian into a qubit representation, which qubits may correspond to the qubits of a non-classical computer. To perform a calculation, a qubit Hamiltonian may be implemented on a system of qubits of a non-classical computer, various unitary operations may be performed on the system of qubits to manipulate the interactions of the system of qubits. If the Hamiltonian to be solved is represented by the qubit Hamiltonian (potentially after various unitary operations), measured parameters of the system of qubits may provide information, which information may comprise all or part of a solution to the problem.

In some cases, a qubit Hamiltonian may be implemented direction on a quantum computer. In some cases, a variational method may be used to implement a qubit Hamiltonian on a quantum computer. Variational methods may include, for example, a variational quantum eigensolver (VQE) and a quantum approximate optimization algorithm (QAOA). In some cases, a term to be variationally reduced (or increased) may include one or more variational parameters. In some cases, a term to be variationally reduced (or increased) may be a term in the qubit Hamiltonian (e.g., a value of an eigenstate, an amplitude of a rotation in one or more axes, etc.). In some cases, a term to be variationally reduced (or increased) is a term in a Hamiltonian representative of a cost function. Variation with respect to a term in a Hamiltonian representative of a cost function may approach an eigenvalue of a quantum Hamiltonian (e.g., the Hamiltonian to be solved/simulated).

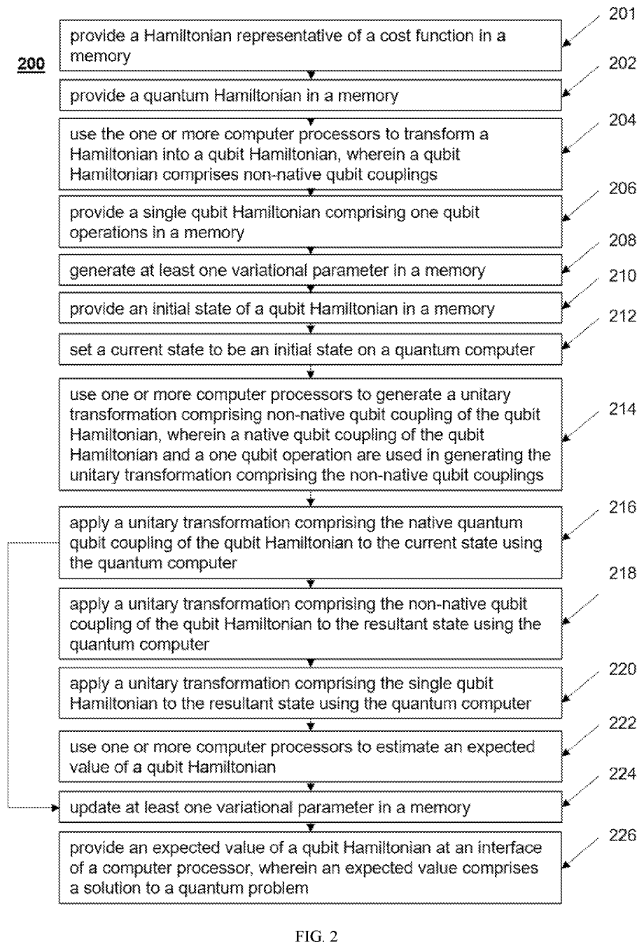

FIG. 2 illustrates a flow chart of an example 200 of the method 100 for solving a quantum problem. Method 100 may comprise one or more steps of method 200. Although the operations herein are example operations of the methods 100 and 200, a person of ordinary skill in the art will recognize many variations based on the teachings described herein. The steps may be completed in any order. Steps may be added or deleted. Some of the steps may comprise sub-steps. Many of the steps may be repeated as often as beneficial to provide a solution to a problem.

A method 200 for solving a quantum problem may comprise providing a Hamiltonian representative of a cost function in a memory operatively coupled to one or more processors according to operation 202.

A method 200 for solving a quantum problem may comprise providing a quantum Hamiltonian in a memory operatively coupled to one or more processors according to operation 202. The quantum Hamiltonian may be representative of a Hamiltonian to be implemented on the quantum computer. An evolution with respect to the quantum Hamiltonian may relate to a reduction of a value of a cost function of a Hamiltonian representative of a cost function. In some cases, the Hamiltonian representative of the cost function may be the same Hamiltonian as the quantum Hamiltonian.

In some cases, a quantum chemistry problem may be represented by a non-interacting Hamiltonian, such as a Hartree-Fock Hamiltonian. A Hartree-Fock Hamiltonian may be an example of a fermionic Hamiltonian. The Hartree-Fock Hamiltonian may be similarly be represented in terms of occupied and virtual electronic states as shown below:

$${H}_{HF} = {\sum }_{i ∈ vir} {Z}_{i} - {\sum }_{i ∈ occ} {Z}_{i}$$

A method 200 for solving a quantum problem may comprise using one or more computer processors to transform a Hamiltonian into a qubit Hamiltonian according to operation 204. Operation 110 of the method 100 may comprise operations 202 and/or 204 of the method 200. In some cases, using the one or more computer processors to transform the Hamiltonian into a qubit Hamiltonian comprises Bravyi-Kitaev transformation. Various methods may be used to map the Hamiltonian into qubit form. In the case of fermions, one example is Bravyi-Kitaev transformation. Another example may be the Jordan-Wigner transformation. Another example may express fermionic states as qubit states using a parity basis. The Bravyi-Kitaev transformation may transform a fermionic Hamiltonian to a qubit representation by as partial sums of both occupation number and parity, thereby reducing non-locality of either operator. A qubit Hamiltonian after a Bravyi-Kitaev transformation may be log N local where N is the total number of qubits.

While finding an eigenstate of a fermionic Hamiltonian H_{fermi} is described, methods, systems, and media described herein may be extended to other systems such as bosonic and spin systems. By using transformations such as Bravyi-Kitaev transformation, a fermionic Hamiltonian may be transformed to a qubit Hamiltonian H_{qubit}. After transformation, the Hamiltonian H_{qubit} may be log N local where N is the total number of qubits.

The sub-set of qubits used to describe H_{qubit} may be referred to as logical qubits. For H_{qubit}, a unitary transformation associated with the Hamiltonian H_{qubit} may be e^{-itH}^{_{qubit}} with a parameter t. A unitary transformation may be implemented as one or more gate operations. For example, in the case of a digital quantum simulation, the unitary operation e^{-itH}^{_{qubit}} may be described by series of two qubit and one qubit gate operations. In another example, in analogue quantum simulations, the Hamiltonian H_{qubit} may directly implemented on a quantum device.

In some cases, the qubit Hamiltonian may be a 2-local qubit Hamiltonian. A 2-local qubit Hamiltonian may be advantageous as it may reduce the number of many-body interactions accounted for in the qubit Hamiltonian. Various methods may be used to reduce the log N local Hamiltonian to a 2-local Hamiltonian.

In some cases, using the one or more processors to transform the Hamiltonian into a qubit Hamiltonian is performed using perturbative gadgets. Perturbative gadgets may be used to reduce a log N local Hamiltonian to a 2-local Hamiltonian. In some cases, one may use perturbative gadgets to transform H_{qubit} into 2-local qubit Hamiltonian H. Perturbative gadgets may introduce additional qubits, called ancilla qubits, which may be distinguished from logical qubits. Perturbative gadgets may yield a Hamiltonian of the form:

H=H_{XX}+H_{ZZ}+H_{X}+H_{Z}

where

$$\begin{matrix}{H}_{XX} = {\sum }_{ij} {h}_{ij}^{XX} {X}_{i} {X}_{j} , & {H}_{ZZ} = {\sum }_{ij} {h}_{ij}^{ZZ} {Z}_{i} {Z}_{j} \\ {H}_{X} = {\sum }_{i} {h}_{i}^{X} {X}_{i} , & {H}_{Z} = {\sum }_{i} {h}_{i}^{Z} {Z}_{i}\end{matrix}$$

Here i, j may represent both logical and ancilla qubits. In some cases, a quantum problem comprises a quantum chemistry problem, such as a ground or an excited eigenstate.

In some cases, a method 100 may additionally comprise one or more initialization operations. Example initialization operations which may, optionally, be used with the method 100 comprise operations 206, 208, 210, and 212.

A method 200 may comprise providing a single qubit Hamiltonian comprising one qubit operations in a memory according to an operation 206. A single qubit Hamiltonian may comprise one or more one qubit operations. A one qubit operation may comprise a one qubit rotation operator. For example, a one qubit rotation operator may be a rotation in X, in Y, in Z, or a rotation along on axis in any other convenient coordinate system.

A method 200 may comprise generating at least one variational parameter in a memory operatively coupled to one or more computer processors according to a step 208. A method for solving a quantum problem may comprise using one or more computer processors to generate a set of variational parameters (αₖ, βₖ). Memory operatively connected to one or more computer processors may be configured to store a set of variational parameters (αₖ, βₖ), which may similarly be represented (α, β)=(\vec{αₖ}, \vec{βₖ}), k ∈ [1, M], where M is a number of repetitions (e.g., the ansatz depth).

A method 200 may comprise providing an initial state of a qubit Hamiltonian in a memory operatively coupled to one or more computer processors according to operation 210. In some cases, one or more computer processors may generate or prepare an initial state of a qubit Hamiltonian. An initial state may be a product state. In a qubit representation, combinatorial optimization problems may be represented by an initial state:

|ψ₀ [symbol] =⊗ᵢ₌₁^{N}|+ [symbol] ᵢ=⊗ᵢ₌₁^{N} [symbol] ᵢ|0 [symbol] ᵢ

where [symbol] ᵢ is the Hadamard gate acting on the i-th qubit. A Hadamard gate may be a single qubit rotation operation. In some cases, for example in quantum chemistry problems, an initial state in an orbital representation may be a Hartree-Fock state

$$\vert {ψ}_{0} 〉 = {\prod }_{i ∈ vir} {X}_{i} \vert 0 〉$$

where vir represents virtual states. The states of the corresponding qubit Hamiltonian may be represented by the following ansatz:

$$\vert ψ ( α , β ) 〉 = ( {{\prod }_{k = 1}}^{M} {V}_{k} ( \vec{{β}_{k}} ) {U}_{k} ( \vec{{α}_{k}} ) ) \times ( {\prod }_{m} {R}_{X} ( {a}_{m} π ) ) \vert 0 〉 .$$

Here |0 [symbol] is a product state |0 . . . 00 [symbol] . The parameters aₘ ∈ {0,1} determines the initial state. For instance, a Hartree-Fock state is a direct product of |0 [symbol] and |1 [symbol] . aₘ=1 if the corresponding qubit m is |1 [symbol] and otherwise aₘ=0 including the ancilla qubits. (α, β)=(\vec{αₖ}, \vec{βₖ}), k ∈ [1, M] are variational parameters and M is a number of repetitions (e.g. the ansatz depth).

Uₖ(\vec{αₖ})=e^{-iα}^{ₖ}^{^{j}}^{H}

is a unitary operator associated with the Hamiltonian H, and

$${V}_{\vec{{β}_{k}}} = {e}^{- i {\sum }_{j} {β}_{k}^{j} {Z}_{j}}$$

is a unitary operator motivated by the initial Hamiltonian Hᵢₙᵢₜᵢₐₗ. R_{X} are the 1-qubit rotation operations for the corresponding qubit m.
Unitary Transformation with Reduced Two-Qubit Interactions

The method 100 of solving a problem using a digital computer operatively coupled to a non-classical computer may comprise using one or more computer processors to generate a unitary transformation according to operation 120. The unitary transformation may comprise an expression of at least one non-native qubit coupling in terms of one or more native qubit couplings and a one qubit operation. The unitary transformation may comprise native qubit couplings and/or operations. In some case, the unitary transformation also comprises non-native qubit operations. The unitary transformation may comprise an expression of a first two-qubit coupling interaction on a first axis using a second two-qubit coupling interaction on a second axis, which axis is orthogonal to the second axis.

The method 200 of solving a problem may comprise using one or more computer processors to generate a unitary transformation comprising non-native qubit coupling of the qubit Hamiltonian, according to an operation 214. In some cases, a native qubit coupling of the qubit Hamiltonian and a one qubit operation are used in generating the unitary transformation comprising the non-native qubit couplings. In some cases, a unitary transformation may comprise XX and X interactions of a qubit Hamiltonian. In some cases, a unitary transformation comprising XX and X interactions comprises an expression in terms of ZZ and Z interactions and one qubit operations. Operation 214 may comprise a variation or example of operation 120 of the method 100. Axes X and X may be orthogonal.

For example, it may be beneficial for a qubit Hamiltonian to be expressed with two-qubit coupling interactions on fewer axes. For example, a quantum simulator may have only native ZZ couplings. One or more processors may generate XX coupling using ZZ couplings via the following example transformation. H_{XX} may be generated from ZZ coupling interaction as shown. First, denote H_{XX} as

$${H}_{XX} = {\sum }_{ij} {h}_{ij}^{XX} {X}_{i} {X}_{j}$$

A Hamiltonian whose XX coupling interactions in H_{XX} is replaced by ZZ coupling interactions may be defined:

$${H}_{XX} ( ZZ ) ≡ {\sum }_{ij} {h}_{ij}^{XX} {Z}_{i} {Z}_{j}$$

As shown below, exp(−itH_{XX}) may be applied using single qubit rotations R_{γ}, by

$$exp ( - {itH}_{XX} ) = exp ( - i \frac{3 π}{4} {\sum }_{i} {Y}_{i} ) exp ( - {itH}_{XX} ( Z Z ) ) exp ( i \frac{3 π}{4} {\sum }_{i} {Y}_{i} )$$

### Where

$${U}_{k} ( {α}_{k} ) = {e}^{- i {α}_{k} ( {H}_{Z Z} + {H}_{Z} )} {e}^{- i {α}_{k} ( {H}_{XX} + {H}_{X} )} = {e}^{- i {α}_{k} ( {H}_{Z Z} + {H}_{Z} )} {R}_{Y} {e}^{i {α}_{k} ( {H}_{XX} ( Z Z ) + {H}_{X} ( Z ) )} {R}_{Y}^{†}$$

As shown above, in at least one example, native ZZ couplings may be enough to run the general quantum simulation (e.g., without two-qubit coupling interactions in other axes).

Similar to the Quantum Approximate Optimization Algorithm (QAOA), the total quantum simulation (e.g. an ansatz) for the state preparation may then be expressed as:

$$\vert ψ 〉 = {\prod }_{k} [ exp ( - i {β}_{k} {H}_{HF} )$$

$$exp ( - i {α}_{k} ( {H}_{X} + {H}_{Y} + {H}_{Z} ) )$$

$$exp ( - i \frac{3 π}{4} {\sum }_{i} {Y}_{i} ) exp ( - i {α}_{k} {H}_{XX} ( ZZ ) ) exp ( i \frac{3 π}{4} {\sum }_{i} {Y}_{i} )$$

$$exp ( - i {α}_{k} {H}_{Z Z} ) ] \vert {ψ}_{0} 〉$$

After the above quantum simulation, the expectation value of the Hamiltonian may be calculated by the quantum hardware through the projective measurements. This part may be similar to the Variational Quantum Eigensolver (VQE).

When the repetition number M is taken to infinity, this ansatz may reproduce the adiabatic state preparation

|ψ [symbol] = [symbol] exp(−i∫(A(t)Hᵢₙᵢₜᵢₐₗ+B(t)H)dt)|0

[symbol]

The variational parameters (α, β) determine the schedule functions A(t) and B(t). Accordingly, this ansatz finds a ground state of H.

### Implementation on a Non-Classical Computer

The method 100 of solving a problem using a digital computer operatively coupled to a non-classical computer may comprise embedding a qubit Hamiltonian on a non-classical computer. The embedding may comprise implementation of a series of gate operations on the quantum simulator, e.g., an ansatz. The embedding may comprise one or more sub-operations. For example, the one or more sub-operations of the method 100 may comprise one or more of operations 212, 216 and 218.

In some cases, embedding a qubit Hamiltonian on a non-classical computer may comprise implementing a unitary transformation on a non-classical computer to apply at least one non-native qubit coupling, according to an operation 130. In some cases, embedding a qubit Hamiltonian on a non-classical computer may comprise implementing a unitary transformation comprising non-native qubit couplings on the non-classical.

In some cases, apply a unitary transformation comprising the single qubit Hamiltonian to the resultant state using the quantum computer according to an operation 220. In some cases, embedding a qubit Hamiltonian on a non-classical computer may comprise apply a unitary transformation comprising XX coupling and X interactions Hamiltonian corresponding to at least one variational parameter using a quantum computer. The one or more sub-operations of the method 100 may comprise applying one or more single qubit rotations gates. The one or more sub-operations of the method 100 may comprise one or more entanglement gates. The one or more sub-operations of the method 100 may comprise one or more measurement operations. The one or more sub-operations may be repeated any number of times.

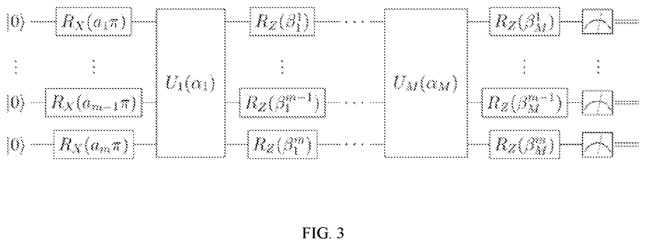

FIG. 3 shows the operation of an example quantum simulator. Each horizontal line may represent the state of a qubit, and each box may represent the action of various gate operations. As shown, some operation may act on a single qubit, while others may act on multiple qubits. At the end of each line, the last box represents a measurement of the state of the qubit on that line. An ansatz may be an expression of a quantum circuit. A quantum circuit may comprise a series of gate operations, which gate operations may be sequentially applied to perform a method of solving a quantum problem. An ansatz may be repeated a number of times M. Increasing a number of repetitions may increase computational accuracy. Improved quantum circuits may improve computational accuracy while reducing the number M.

A method 200 may comprise setting a current state to be an initial state on a quantum computer according to operation 212. As the circuit progresses, a Hamiltonian representing the states of the qubits may evolve. An initial Hartree-Fock Hamiltonian may operate on the set of logical qubits, represented below:

$${H}_{initial} = {\sum }_{i ∈ logical} {h}_{i}^{i n i t i a l} {Z}_{i}$$

At the end of the simulation, the state of the qubits may relate to the expectation of the Hamiltonian below:

E(α,β)= [symbol] ψ(α,β)|H|ψ(α,β)

[symbol]

A method 200 may comprise using one or more computer processors to estimate an expected value of a qubit Hamiltonian according to an operation 222. A method 200 may comprise updating at least one variational parameter in a memory according to an operation 224. At each iteration, the value of the variational parameters and the obtained expectation value E may be sent to a classical optimizer, which may return updated variational parameters. This process may be iterated until a convergence condition of a classical optimizer is satisfied. In some cases, the stopping criterion comprises a completion of a selected number of iterations. In some cases, the stopping criterion comprises finding that a change in the expected value of the qubit Hamiltonian is below a threshold condition.

The example shown in FIG. 3 may relate to a qubit Hamiltonian with X, Z, XX, and ZZ interactions. However, the details of the implementation of Uₖ(\vec{αₖ}) may depend on hardware. For example, some quantum hardware may have limited available gate operations (e.g., native operations). For example, some quantum hardware may have available gate operations (e.g., native operations) in a single axis. In some cases, it may be beneficial to perform operations on a single axis rather than multiple axes to maintain fidelity. Systems and methods of the present disclosure may reduce the number of types of two qubit gate operations (e.g., native couplings). Methods, systems, and media of the present disclosure may improve upon existing methods for implementing Uₖ(\vec{αₖ}).

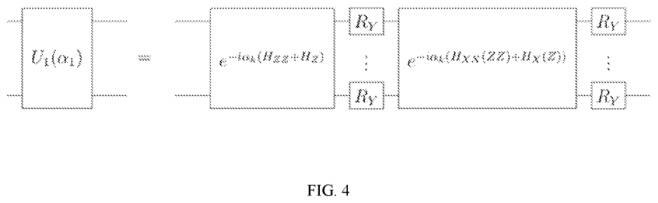

FIG. 4 shows an example implementation of a unitary transformation with reduced two-qubit couplings on a quantum annealer. Like the example of FIG. 3, some operations may act on a single qubit, while others may act on multiple qubits. An ansatz may be an expression of a quantum circuit. A quantum circuit may comprise a series of gate operations, which gate operations may be sequentially applied to perform a method of solving a quantum problem. An ansatz may be repeated a number of times M. Increasing a number of repetitions may increase computational accuracy. Improved quantum circuits may improve computational accuracy while reducing the number M.

The method 100 of solving a problem using a digital computer operatively coupled to a non-classical computer may comprise applying a unitary transformation comprising at least one non-native qubit coupling, according to an operation 130. In some cases, implementing the unitary transformation on the non-classical computer may comprise applying a two-qubit coupling interaction along the first axis.

The method 200 of solving a quantum problem may comprise applying a unitary transformation comprising the native quantum computer interaction of the qubit Hamiltonian to the current state using the quantum computer, according to an operation 216. In some cases, the unitary transformation comprises native qubit couplings of the qubit Hamiltonian and comprises a second variational parameter of the set of variational parameters.

The method 200 of solving a quantum problem may comprise applying the unitary transformation comprising the non-native quantum computer interactions of the qubit Hamiltonian to the resultant state using the quantum computer, according to an operation 218. In some cases, the unitary transformation comprises non-native quantum computer interaction of the qubit Hamiltonian and a third variational parameter of the set of variational parameters. The unitary transformation comprising non-native computing interaction may comprise a native qubit coupling of the qubit Hamiltonian and a one qubit operation. A method 200 may comprise applying a unitary transformation comprising XX and X interactions of a qubit Hamiltonian corresponding to at least one variational parameter using a quantum computer. An operation 218 of the method 200 may comprise an example of an operation 140 of the method 100.

The method 200 of solving a quantum problem may comprise applying a unitary transformation comprising a single qubit Hamiltonian to the resultant state using the quantum computer, according to an operation 220. The single qubit Hamiltonian may comprise a variational parameter comprising an amplitude of rotation.

In some cases, a method of solving a problem using a digital computer operatively coupled to a non-classical computer may comprise providing an expected value of the qubit Hamiltonian at an interface, wherein the expected value comprises the solution to the problem.

As described above, the total quantum simulation (e.g., an ansatz) for the state preparation may be expressed as:

$$\vert ψ 〉 = {\prod }_{k} [ exp ( - i {β}_{k} {H}_{HF} )$$

$$exp ( - i {α}_{k} ( {H}_{X} + {H}_{Y} + {H}_{Z} ) )$$

$$exp ( - i \frac{3 π}{4} {\sum }_{i} {Y}_{i} ) exp ( - i {α}_{k} {H}_{XX} ( ZZ ) ) exp ( i \frac{3 π}{4} {\sum }_{i} {Y}_{i} )$$

$$exp ( - i {α}_{k} {H}_{Z Z} ) ] \vert {ψ}_{0} 〉$$

The unitary transformation of FIG. 4 may substitute for U₁(α₁) in FIG. 3 using the relation for Uₖ(αₖ):

$${U}_{k} ( {α}_{k} ) = {e}^{- i {α}_{k} ( {H}_{Z Z} + {H}_{Z} )} {e}^{- i {α}_{k} ( {H}_{XX} + {H}_{X} )} = {e}^{- i {α}_{k} ( {H}_{Z Z} + {H}_{Z} )} {R}_{Y} {e}^{i {α}_{k} ( {H}_{X X} ( Z Z ) + {H}_{X} ( Z ) )} {R}_{Y}^{†}$$

FIG. 4 shows an example implementation of a unitary transformation with reduced two-qubit interactions on a quantum annealer. The example implementation of FIG. 4 may substitute for Uₖ(αₖ) in the example of FIG. 3. Any of the implementation steps described with respect to FIG. 3 may be equally applicable using the example implementation of a unitary transformation of FIG. 4.

The method 100 of solving a problem using a digital computer operatively coupled to a non-classical computer may comprise providing an expected value of a qubit Hamiltonian at an interface of a computer processor, wherein an expected value comprises a solution to a problem according to an operation 140. The method 200 may comprise providing an expected value of the of a qubit Hamiltonian at an interface of a computer processor, wherein an expected value comprises a solution to a quantum problem according to an operation 226. An operation 226 of the method 200 may comprise an example of an operation 140 of the method 100.

### Examples

### H₂ Model-

In the minimal basis set, the Bravyi-Kitaev Hamiltonian of a hydrogen molecule is

H=h₀+h₁(IZ+ZI)+h₂ZZ+h₃XX

For the nuclear distance D=1 Å,
h₀=−0.5400662794919306,
h₁=0.26752864994208597,
h₂=0.009014930058166282,
h₃=0.19679058348547024.
   As described above, we used the relation:

$${e}^{i \frac{3 π}{4} Y} {e}^{itZ} {e}^{- i \frac{3 π}{4} Y} = {e}^{- i \frac{π}{4} Y} {e}^{itZ} {e}^{i \frac{π}{4} Y} = {e}^{itX}$$

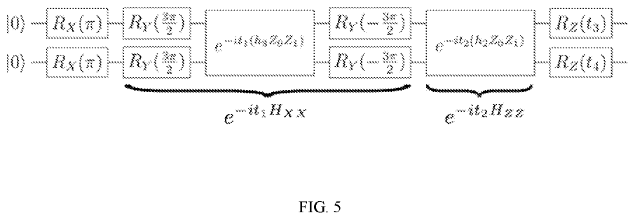

We considered the circuit shown in FIG. 5. The first layer generates the Hartree-Fock state |11 [symbol] . Then we apply the unitary transformation

$${e}^{- i ( \frac{{t}_{3}}{2} ZI + \frac{{t}_{4}}{2} IZ )} {e}^{- i {t}_{2} {H}_{Z Z}} {e}^{- i {t}_{1} {H}_{XX}} .$$

The variational parameters are {t₁, t₂, t₃, t₄}. In the case of a hydrogen molecule, this one set of the transformations was enough to generate a quantum state which achieves the chemical accuracy. E=−1.1011502 with {t₁, t₂, t₃, t₄}={0.89676859, 0.19719053, 0.79110337, 0.4794228}. The exact energy is E_{exact}=1.1011503.

### Generic Spin Model-

Next, we considered a toy model which shows the use of perturbative gadgets and reduction of the number of measurements. We used the following Hamiltonian:

$$H = {\underbrace{{X}_{0}}}_{{A}_{1}} {\underbrace{{X}_{1}}}_{{B}_{1}} {\underbrace{{Z}_{2}}}_{{C}_{1}} + {\underbrace{{X}_{0}}}_{{A}_{2}} {\underbrace{{Z}_{1}}}_{{B}_{2}} {\underbrace{{X}_{2}}}_{{C}_{2}} + {\underbrace{{Z}_{0}}}_{{A}_{3}} {\underbrace{{X}_{1}}}_{{B}_{3}} {\underbrace{{X}_{2}}}_{{C}_{3}}$$

The energy spectrum of this Hamiltonian is E=[−3., −1., −1., −1.,1.,1.,1.,3.]. If we were to simulate this Hamiltonian directly on a quantum simulator, the simulator needs to have 3 qubit couplings which is technically challenging. Furthermore, in order to evaluate the expectation value of the Hamiltonian, one needs to evaluate each term separately because of the qubit-wise non-commutativity of all the terms. In order to overcome these difficulties, we use the perturbative gadgets to translate the Hamiltonian into another 2-local Hamiltonian with only XX and ZZ couplings for 2-qubit interactions.

We introduced additional 9 qubits, labeled by indices running from 3 to 11. By using the perturbative gadgets, we rewrote the original Hamiltonian as:

$$H = \frac{{Δ}_{1}}{4} ( 9 - {Z}_{3} {Z}_{4} - {Z}_{4} {Z}_{5} - {Z}_{5} {Z}_{3} - {Z}_{6} {Z}_{7} - {Z}_{7} {Z}_{8} - {Z}_{8} {Z}_{6} - {Z}_{9} {Z}_{10} - \\ {Z}_{10} {Z}_{11} - {Z}_{11} {Z}_{9} ) + \sqrt[3]{\frac{{Δ}_{1}^{2}}{6}} ( {X}_{0} {X}_{3} + {X}_{1} {X}_{4} + {Z}_{2} {X}_{5} + {X}_{0} {X}_{6} + {Z}_{1} {X}_{7} + \\ {X}_{2} {X}_{8} + {Z}_{0} {X}_{9} + {X}_{1} {X}_{10} + {X}_{2} {X}_{11} ) + 9 \sqrt[3]{\frac{{Δ}_{1}}{36}}$$

We checked that for Δ₁=10⁹ the low-lying energies are 8 states with −2.999 and the excited states are −0.999, which is the same as the original spectrum.

This Hamiltonian contains XZ couplings. While it is possible to realize a unitary transformation associated with XZ couplings by using ZZ couplings and single qubit rotations, we used the perturbative gadget to rewrite XZ couplings with ZZ couplings and XX couplings.

By introducing new qubits labeled by indices from 12 to 14, the perturbative gadget provided a Hamiltonian with only XX and ZZ couplings:

$$H = \frac{{Δ}_{1}}{4} ( 9 - {Z}_{3} {Z}_{4} - {Z}_{4} {Z}_{5} - {Z}_{5} {Z}_{3} - {Z}_{6} {Z}_{7} - {Z}_{7} {Z}_{8} - {Z}_{8} {Z}_{6} - {Z}_{9} {Z}_{10} - {Z}_{10} {Z}_{11} - {Z}_{11} {Z}_{9} ) + \sqrt[3]{\frac{{Δ}_{1}^{2}}{6}} ( {X}_{0} {X}_{3} + {X}_{1} {X}_{4} + {X}_{0} {X}_{6} + {X}_{2} {X}_{8} + {X}_{1} {X}_{10} + {X}_{2} {X}_{11} ) + 9 \sqrt[3]{\frac{{Δ}_{1}}{36}} + \frac{{Δ}_{2}}{2} ( 1 - {Z}_{12} ) + \frac{{Δ}_{2}}{2} ( 1 - {Z}_{13} ) + \frac{{Δ}_{2}}{2} ( 1 - {Z}_{14} ) + 2 {Δ}_{2}^{1 / 3} ( ( {X}_{5} + 1 ) + ( {X}_{7} + 1 ) + ( {X}_{9} + 1 ) ) - ( \sqrt[3]{\frac{{Δ}_{1}^{2}}{6}} {Z}_{2} \frac{1 + {Z}_{12}}{2} + \sqrt[3]{\frac{{Δ}_{1}^{2}}{6}} {Z}_{1} \frac{1 + {Z}_{13}}{2} + \sqrt[3]{\frac{{Δ}_{1}^{2}}{6}} {Z}_{0} \frac{1 + {Z}_{14}}{2} ) + {Δ}_{2}^{2 / 3} ( {X}_{5} + 1 ) {X}_{12} + {Δ}_{2}^{2 / 3} ( {X}_{7} + 1 ) {X}_{13} + {Δ}_{2}^{2 / 3} ( {X}_{9} + 1 ) {X}_{14} + \sqrt[3]{\frac{{Δ}_{1}^{2}}{6}} \frac{{Δ}_{2}^{2 / 3}}{2} ( {Z}_{2} \frac{1 - {Z}_{12}}{2} + {Z}_{1} \frac{1 - {Z}_{13}}{2} + {Z}_{0} \frac{1 - {Z}_{14}}{2} )$$

Since this Hamiltonian contains only XX and ZZ couplings as 2-qubit couplings, one can, optionally, apply method disclosed herein above to reduce represent the XX coupling interactions as ZZ coupling interactions.

### Summary of Numerical Results-

Numerical results for a hydrogen molecule with a nuclear separation distance 1 Å and a square shape P4 molecule with the separation distance 2 Å were as follows. The configuration of P4 molecule may be hard to simulate because of the degeneracy. We considered

$$\vert ψ 〉 = {\prod }_{k = 1}^{M} {e}^{- i {β}_{k}^{i} {Z}_{i}} {e}^{- i {α}_{k} H} \vert {ψ}_{HF} 〉$$

Here, we assumed that the Hartree Fock Hamiltonian takes the form of

$${H}_{HF} = {\sum }_{i} {h}_{i} {Z}_{i}$$

We assigned individual variational parameter βⁱₖ for each Z.

The obtained energies for a hydrogen molecule (H₂ (D=1): Exact Energy=−1.10115033) were as follows:

| Iteration Number | [symbol] H [symbol] |
|---|---|
| 1 | −1.10115011235169 |

The obtained energies a P4 molecule (P₄ (D=2): Exact Energy=−1.89784939) were as follows:

| Iteration Number | [symbol] H [symbol] |
|---|---|
| 1 | −1.7435188261655559 |
| 2 | −1.8567973915639107 |
| 3 | −1.8914305686278854 |

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method for solving a problem using a digital computer operatively coupled to a non-classical computer, wherein said digital computer comprises computer memory and one or more computer processors operatively coupled to said memory, wherein a solution to said problem comprises a quantum state, the method comprising:
(a) providing a qubit Hamiltonian in said memory, wherein said qubit Hamiltonian comprises at least one non-native qubit coupling or operation;
(b) using said one or more computer processors to generate a unitary transformation comprising said at least one non-native qubit coupling or operation of said qubit Hamiltonian, wherein a native qubit coupling or operation of said qubit Hamiltonian and a one qubit operation are used in generating said unitary transformation comprising said at least one non-native qubit coupling or operation;
(c) applying said unitary transformation on said non-classical computer; and
(d) providing an expected value of said qubit Hamiltonian at an interface of said one or more computer processors, wherein said expected value comprises said solution to said problem.

2. The method of claim 1, wherein said qubit Hamiltonian is a two-local qubit Hamiltonian.

3. The method of claim 2, wherein said two-local qubit Hamiltonian comprises one or more of XX, ZZ, X and Z interactions.

4. The method of claim 1, wherein said qubit Hamiltonian comprises native XX and ZZ couplings and native X and Z one qubit operations.

5. The method of claim 1, wherein said expected value is an expected value of a ground state energy or an excited state energy.

6. The method of claim 1, further comprising: (i) providing a Hamiltonian in said memory; and (ii) using said one or more computer processors to transform said Hamiltonian into said qubit Hamiltonian.

7. The method of claim 6, wherein said Hamiltonian is in a form selected from the group consisting of a second quantized fermionic Hamiltonian, a second quantized bosonic Hamiltonian, and a spin Hamiltonian.

8. The method of claim 6, wherein said using said one or more computer processors to transform said Hamiltonian into said qubit Hamiltonian comprises a Bravyi-Kitaev transformation.

9. The method of claim 6, wherein (i) comprises using perturbative gadgets

10. The method of claim 6, wherein said Hamiltonian is a Hamiltonian representative of a cost function.

11. The method of claim 10, wherein said Hamiltonian representative of said cost function is a molecular Hamiltonian, said quantum Hamiltonian, or a second quantum Hamiltonian different from said quantum Hamiltonian.

12. The method of claim 10, comprising providing a quantum Hamiltonian in said memory, wherein said quantum Hamiltonian is representative of a Hamiltonian to be implemented on said non-classical computer and wherein an evolution with respect to said quantum Hamiltonian relates to a reduction of a value of said cost function.

13. The method of claim 12, wherein said quantum Hamiltonian is an Ising or a quadratic unconstrained binary optimization (QUBO) Hamiltonian.

14. The method of claim 1, wherein said non-classical computer comprises a quantum simulator, a quantum annealer, or a gate model quantum computer.

15. The method of claim 1, further comprising:
(i) generating an initial value for each variational parameter of a set of variational parameters in said memory;
(ii) providing a single qubit Hamiltonian, wherein said single qubit Hamiltonian comprises a first variational parameter of said set of variational parameters;
(iii) providing an initial state in said memory; and
(iv) setting a current state on said quantum computer to be said initial state.

16. The method of claim 15, further comprising: until a stopping criterion is met:
(v) applying a unitary transformation comprising a native qubit coupling of said qubit Hamiltonian to said current state using said non-classical computer, wherein said unitary transformation comprising said native qubit coupling of said qubit Hamiltonian comprises a subset of variational parameters of said set of variational parameters;
(vi) applying said unitary transformation comprising said at least one non-native qubit coupling of said qubit Hamiltonian to a resultant state using said non-classical computer, wherein said unitary transformation comprising said at least one non-native qubit coupling of said qubit Hamiltonian comprises said subset of variational parameters of said set of variational parameters; and
(vii) applying a unitary transformation comprising said single qubit Hamiltonian to the resultant state using said non-classical computer, wherein said unitary transformation comprising said single qubit Hamiltonian comprises said subset of variational parameters of said set of variational parameters.

17. The method of claim 16, further comprising:
(viii) repeating (v)-(vii) at least one time;
(ix) using said one or more computer processors to estimate said expected value of said Hamiltonian, wherein said Hamiltonian is representative of a cost function; and
(x) updating said set of variational parameters in said memory.

18. A method for simulating a quantum chemistry problem using a digital computer operatively coupled to a simulator of a non-classical computer, wherein said digital computer comprises computer memory and one or more computer processors operatively coupled to said memory, wherein a simulated solution to said problem comprises a quantum state, the method comprising:
(a) providing a qubit Hamiltonian in said memory, wherein said qubit Hamiltonian comprises at least one non-native qubit coupling or operation;
(b) using said one or more computer processors to generate a unitary transformation comprising said at least one non-native qubit coupling or operation of said qubit Hamiltonian, wherein a native qubit coupling or operation of said qubit Hamiltonian and a one qubit operation are used in generating said unitary transformation comprising said non-native qubit coupling or operation;
(c) applying said unitary transformation on said non-classical computer; and
(d) providing an expected value of said qubit Hamiltonian at an interface of said one or more computer processors, wherein said expected value comprises said simulated solution to said problem.

19. A system for solving a problem, wherein a solution to said problem comprises a quantum state, the system comprising:
memory configured to store a qubit Hamiltonian, wherein said qubit Hamiltonian comprises at least one non-native qubit coupling or operation;
a communications interface configured to communicate with a non-classical computer; and
one or more computer processors operatively coupled to said memory, wherein said one or more computer processors are individually or collectively programmed to (1) generate a unitary transformation, wherein a native qubit coupling or operation of said qubit Hamiltonian and a one qubit operation are used in generating said unitary transformation comprising said non-native qubit coupling or operation; (3) apply the unitary transformation on the non-classical computer; (4) and provide an expected value of the qubit Hamiltonian at an interface of said one or more computer processors, wherein the expected value comprises the solution to the problem.

20. A non-transitory computer readable medium comprising machine-executable code, that upon execution by a digital computer operatively coupled to a non-classical computer, implements a method for solving a problem, wherein said digital computer comprises one or more computer processors and a memory and wherein a solution to said problem comprises a quantum state, the method comprising:
(a) providing a qubit Hamiltonian in said memory, wherein said qubit Hamiltonian comprises at least one non-native qubit coupling or operation;
(b) using said one or more computer processors to generate a unitary transformation comprising said non-native qubit couplings or operation of said qubit Hamiltonian, wherein a native qubit coupling or operation of said qubit Hamiltonian and a one qubit operation are used in generating said unitary transformation comprising said non-native qubit coupling or operation;
(c) applying said unitary transformation on said non-classical computer; and
(d) providing an expected value of said qubit Hamiltonian at an interface of said one or more computer processors, wherein said expected value comprises said solution to said problem.
